(19) United States
(12) Patent Application Publication
(10) Pub. No.: US 2025/0319887 A1
(43) Pub. Date: Oct. 16, 2025

(54) Computer-Implemented Method and System for Planning the Behavior of a Vehicle

(71) Applicant: Robert Bosch GmbH, Stuttgart (DE)

(72) Inventor: Marcel Hallgarten, Ehningen (DE)

(21) Appl. No.: 19/092,443

(22) Filed: Mar. 27, 2025

(30) Foreign Application Priority Data
Apr. 10, 2024 (DE) 10 2024 203 268.9

(51) Int. Cl. B60W 50/00; B60W 30/09; B60W 30/12; B60W 30/16; B60W 30/18; G06F 16/3331

(52) U.S. Cl. CPC B60W 50/0098; B60W 30/09; B60W 30/12; B60W 30/16; B60W 30/18163; G06F 16/3331; B60W 2552/10; B60W 2720/10; B60W 2754/30

(57) ABSTRACT

A concept for planning a behavior of a vehicle in a traffic scene expands planning competencies of a rule-based planner so that the rule-based planner can also be used for behavioral planning in more complex scenarios. The rule-based planner performs behavioral planning based on a scene representation of the traffic scene that replicates at least one planning scenario from a planner-specific set of predefined planning scenarios. A text-based neural network is used for selection of the at least one planning scenario. Based on the scene representation, at least one text query describing the traffic scene is generated for the neural network. The at least one query requests a behavioral recommendation that is supported by the planner-specific set of predefined planning scenarios. Based on the at least one text query, the neural network generates a text-based behavioral recommendation, which is assigned to at least one of the predefined planning scenarios.

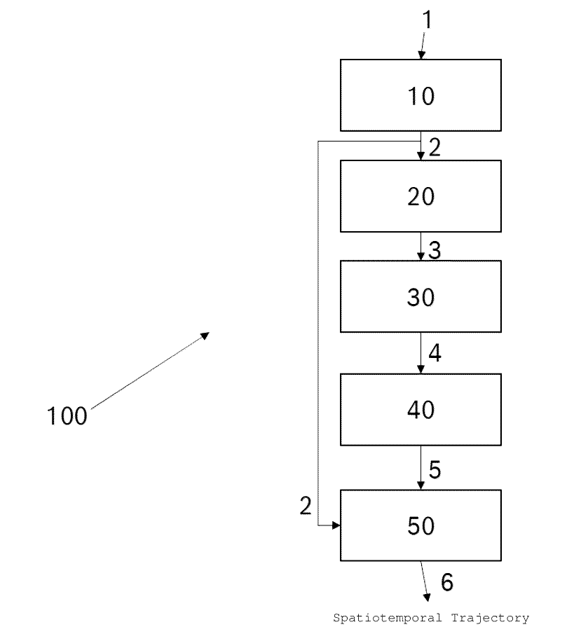

This application claims priority under 35 U.S.C. § 119 to patent application no. DE 10 2024 203 268.9, filed on Apr. 10, 2024 in Germany, the disclosure of which is incorporated herein by reference in its entirety.

### BACKGROUND

The disclosure relates to a computer-implemented method and system for planning the behavior of a vehicle in a traffic scene. A rule-based planner is used whose behavioral planning replicates at least one planning scenario from a planner-specific set of predefined planning scenarios. The behavioral planning of the rule-based planner is based on a scene representation of the traffic scene generated from aggregated scene-specific information.

The autonomous driving task involves controlling an ego vehicle based on aggregated scene-specific information, particularly based on sensor data such as radar, lidar, and RGB camera, in order to reach a destination as quickly, comfortably, and safely as possible. During this process, traffic rules must be observed and collisions with infrastructure elements and/or other participants in the traffic scene must be avoided. This driving task can be divided into the subtasks of perception, prediction, planning and control.

The perception task involves extracting relevant information from the aggregated scene-specific information, such as location and status information on static and dynamic objects in the traffic scene, particularly other traffic participants. Furthermore, at the perception level, road markings can be identified and traffic signs or similar can be detected and reconciled with map data. In this way, an environmental model is generated as a scene representation of the current traffic scene.

Prediction is used to estimate the future development of the traffic scene, particularly the behavior of other participants in the traffic scene and dynamic objects.

Planning uses the environmental model and the prediction of the future development of the traffic scene to plan the future behavior of the ego vehicle. One or more eligible trajectories for the ego vehicle are often generated for this purpose. Each trajectory includes position data along with status data of the ego vehicle, as appropriate, for a predefined number of consecutive time points. The status data typically describes the movement status of the ego vehicle, such as speed, acceleration, and/or orientation, at the particular time. The result of the planning is then implemented by correspondingly controlling the ego vehicle's actuators. Planning in the form of trajectory data proves to be advantageous, since trajectory data can usually be directly adjusted.

A number of rule-based planners are known from practice, such as the Intelligent Driver Model (IDM) or the Predictive Driver Model (PDM). Both planners provide quantitative planning in the form of trajectories along a predefined lane line, wherein a predefined minimum distance to the vehicle ahead and adjusting to a target speed during free travel is maintained. Planning by rule-based planners for these simple planning scenarios is very robust and is typically optimized for comprehensible optimization criteria so that it is also interpretable.

However, the known rule-based planners are unable to generalize beyond such simple planning scenarios, as they are limited to a planner-specific set of predefined planning scenarios. They do not provide reliable, safe planning results for scenarios that deviate from the predefined planning scenarios and/or require more extensive planning competencies. Examples include scenarios where a lane centerline has not been detected or it is necessary to move away from the lane centerline because an obstacle has been detected, or scenarios requiring targeted interaction with other traffic participants. In addition, rule-based planners are not able to compensate for perception-level errors, such as errors in object detection or errors in the map being used.

The use of a Large Language Model (LLM) for behavioral planning of autonomous vehicles is also known. The publication by Jiageng Mao et al. “GPT-Driver: Learning to Drive with GPT” discloses a way to generate text queries, called prompts, as inputs to an LLM that describe a traffic scene and request behavioral planning so that the LLM provides trajectory data for the ego vehicle in response.

LLMs, such as General Pretrained Transformer (GPT) from OpenAI or Llama from Meta, are composed of several billion parameters and are trained on datasets of the magnitude of the Internet. Accordingly, they have excellent abilities to “understand” described situations as well as to correctly grasp cause and effect, and consequently also have very good generalization capability.

Nevertheless, LLMs' planning results fell short of expectations. One reason for this is that generating trajectories for an ego vehicle is a quantitative problem, and LLMs often have deficiencies in solving quantitative problems. Furthermore, it cannot be ruled out that LLMs will produce planning results that do not match reality, which can lead to significant safety risks. It is also problematic that LLMs are relatively slow, so their behavioral planning is typically not capable of real-time operation.

### SUMMARY

According to the disclosure, a planning concept is proposed that expands the planning competencies of a rule-based planner so that the rule-based planner can also be used for behavioral planning in more complex scenarios, and also provide reliable planning results for such scenarios.

According to the disclosure, this is achieved by using a text-based neural network, particularly an LLM, for selecting the at least one planning scenario that the rule-based planner replicates.

For this purpose, at least one text query describing the traffic scene is generated for the neural network based on the scene representation. This prompt requests a behavioral recommendation that is supported by the planner-specific set of predefined planning scenarios, which is thus limited by the planner-specific set of predefined planning scenarios. Based on the prompt, the neural network then generates a corresponding text-based behavioral recommendation. This is assigned to at least one of the predefined planning scenarios, which is generally possible due to the restriction of the prompt request. In this way, at least one of the predefined planning scenarios is selected to serve as a basis for the behavioral planning of the rule-based planner.

The disclosure recognizes that, by appropriately combining a classical rule-based planner with an LLM, the particular generalization capabilities of an LLM can be used to effectively implement the rule-based planner even in more complex scenarios and to generate reliable, safe planning results. Thus, the combination of both model types can capture, “understand,” and specifically solve complex scenarios when the LLM proposes behavior for the ego vehicle, taking into account the possible developments of the traffic scene and, in particular, the interaction of traffic participants. This qualitative proposal is then implemented safely and comfortably in quantitative terms by the rule-based planner.

With this approach, the safety of the behavior planned according to the disclosure can even be guaranteed, provided that the underlying perception can be assumed to be error-free, since the corresponding trajectory is generated by a rule-based planner. Additionally, the planning results generated according to the disclosure are understandable and interpretable because the LLM's behavioral suggestions are in language form, and the rule-based planner allows for interpretability at the trajectory level. This is particularly true if the planning of the rule-based planner is optimized with regard to a comprehensible optimization criterion, such as driving comfort and/or travel progress along the route.

An essential aspect of the method according to the disclosure is that the behavioral recommendations generated by the LLM are limited by the planner-specific set of predefined planning scenarios. In a preferred embodiment of the disclosure, this set comprises at least one of the following planning scenarios, driving along a target line in a lane, adjusting to a predefined minimum distance from a vehicle ahead, adjusting to a target speed, changing lanes, and avoiding an obstacle.

At this point, it should be expressly noted that the above list of planning scenarios should by no means be understood as exhaustive. The rule-based planner or planners used in the context of the disclosure may also be configured for additional planning scenarios.

If the LLM provides a behavioral recommendation for a more complex maneuver in a given traffic scene, for example suggesting a passing maneuver, this could also be assigned to several planning scenarios, which are then applied sequentially or in an overlapping manner to implement the behavioral recommendation. In the case of a passing maneuver, for example, these could be the planning scenarios “brake”, “lane change,” or “follow lane with lane deviation” and/or “avoid an obstacle”. Alternatively, the LLM could also directly suggest these planning scenarios. In this way, the LLM makes the qualitative decision to initiate a passing maneuver at a specific time. The rule-based planner then takes over the quantitative detailed planning, providing corresponding trajectory data.

The planning concept according to the disclosure also provides safe planning results in so-called “long-tail” scenarios that require a good understanding of the traffic scene, and is clearly superior to planning by a rule-based planner alone. As an example of a “long-tail” scenario, consider a traffic scene in which a ball rolls onto the roadway. The rule-based planner would only recognize the ball as a small obstacle that can be safely driven over. Accordingly, the rule-based planner would not plan any special measures for continuing the journey of the ego vehicle. In contrast, the LLM recognizes a particular hazardous situation in the ball rolling onto the roadway, as a child could run onto the roadway. Because this situation requires special attention, the LLM will provide a behavioral recommendation such as “brake” and/or “swerve”, which the rule-based planner then implements according to the planning concept of the disclosure.

According to the disclosure, the text query for the neural network is generated based on a scene representation of the traffic scene. This is preferably rule-based. In particular, it is proposed to use a uniform, fixed predefined structure and a predefined format for the text queries, comprising at least a portion of the following semantic blocks: characterization of the neural network's task as maneuver planning for an ego vehicle in a traffic scene with other participants, specification of the rule-based planner or the planner-specific set of predefined planning scenarios, description of the traffic scene through the scene representation, description of the predicted future development of the traffic scene, description of the ego vehicle, particularly its past behavior, trajectory traveled (if applicable), and current status, information on the desired navigation target of the ego vehicle, and specification of the neural network's response as a behavioral recommendation for the ego vehicle, which is supported by the planner-specific set of predefined planning scenarios.

The text-based behavioral recommendation of the neural network can also be analyzed using rule-based methods and assigned to at least one of the predefined planning scenarios of the rule-based planner.

In a preferred embodiment of the disclosure, at least one target line for the vehicle's movement is generated based on the behavioral recommendation of the neural network. This describes future behavior or vehicle maneuvers, but not their specific implementation. The target line serves as input for the rule-based planner, which selects a suitable planning scenario and thus generates behavioral planning in the form of trajectory data describing the spatial and temporal movement of the vehicle along the target line. The rule-based planner thus provides specific implementation for the qualitative behavioral recommendation of the neural network.

### BRIEF DESCRIPTION OF THE DRAWINGS

Exemplary embodiments and advantageous further developments of the disclosure are explained in more detail in conjunction with the FIGURE.

The FIGURE shows a block diagram of a computer-implemented system for planning the behavior of a vehicle in a traffic scene, according to the disclosure.

### DETAILED DESCRIPTION

The block diagram of the FIGURE illustrates the interaction of the individual components of a computer-implemented system 100 for planning the behavior of a vehicle in a traffic scene, according to the disclosure.

The starting point for behavioral planning is always the status of a traffic scene 1 at a planning time, particularly the status of all static and dynamic objects and participants in the traffic scene at the planning time. The status of the traffic scene is described by scene-specific information that is aggregated from different sources of information at the planning time or even over a certain time period before and until the planning time. The information sources can be in-vehicle sensors, such as LiDAR sensors, radar sensors and/or RGB cameras installed on the ego vehicle, or non-vehicle sensors, such as LiDAR sensors, radar sensors, and/or RGB cameras installed in or on infrastructure elements or other traffic participants. Other possible sources of information include stored map information, along with traffic rules if applicable, as well as retrievable weather and road condition information, traffic situation information, etc. The information from the different sources is aggregated and processed by a perception level 10 to generate an environmental model as a scene representation 2.

The scene representation 2 serves as input for a rule-based planner 50, whose scope of functions is limited to a number of predefined planning scenarios. Accordingly, based on the scene representation 2, the planner 50 can only perform behavioral planning that corresponds to one of these predefined planning scenarios. For example, the planner 50 could have the following planning scenarios available: driving along a target line in a lane, adjusting to a predefined minimum distance from a vehicle ahead, adjusting to a target speed, changing lanes, and avoiding an obstacle.

According to the disclosure, the scene representation 2 is also used as input for a prompt generator 20, which generates text queries 3, called prompts, for an LLM 30. In response to such a prompt 3, the LLM 30 should provide a behavioral recommendation 4 for the vehicle in the respective traffic scene. According to the disclosure, however, this behavioral recommendation 4 should be limited to behavioral recommendations that can be represented by the planning scenarios supported by the rule-based planner 50.

In the exemplary embodiment described here, the prompts 3 are generated in a rule-based manner and have a uniform, fixed predefined structure and a predefined format. They comprise multiple semantic blocks, so that the information from the individual semantic blocks can be classified based on their position in the prompt. For example, separate semantic blocks may be provided for the following information: characterization of the neural LLM's task as maneuver planning for an ego vehicle in a traffic scene with other participants, specification of the rule-based planner or the planner-specific set of predefined planning scenarios, description of the traffic scene through the scene representation, if necessary, description of the predicted future development of the traffic scene, description of the ego vehicle, particularly its past behavior, trajectory traveled (if applicable), and current status, information on the desired navigation target of the ego vehicle, and specification of the LLM's response as a behavioral recommendation for the ego vehicle, which is supported by the planner-specific set of predefined planning scenarios.

The LLM 30 provides a behavioral recommendation 4 in response to the prompt 3. The behavioral recommendation may be described, for example, by selecting a lane, a desired lane deviation, or by a target line and a maximum speed. Using an evaluation module 40, the response of the LLM 30 is evaluated and assigned to at least one of the predefined planning scenarios of the rule-based planner 50, with which the behavioral recommendation 4 of the LLM 30 can be implemented. The planner 50 then uses this planning scenario to generate an optimal trajectory for the ego vehicle in terms of comfort and safety, following the behavioral recommendation 4 of the LLM 30.

Thus, the LLM 30 is only used for qualitative behavioral planning in the form of a behavioral recommendation. This allows the selection of at least one planning scenario supported by the rule-based planner 50. Based on the planning scenario thus selected, the rule-based planner 50 then performs quantitative behavioral planning 6 for the vehicle in the traffic scene analyzed by the LLM 30.

At this point, it should be noted that the individual components of the system 100 may be configured as components of the vehicle, but individual functions may also be implemented outside the vehicle, such as the prompt generator 20, the LLM 30, the evaluation module 40, and/or the rule-based planner 50. For example, these components may also be realized in a cloud or edge cloud where appropriate data connections are available and appropriate connectivity is ensured.

Finally, it can be determined that the system 100 according to the disclosure has a significantly better generalization capability than a simple rule-based planner. They can generally only follow the current lane, while the system according to the disclosure can also initiate a lane change and thus also follow different lanes. Moreover, the LLM behavioral planner may also “understand” difficult scenarios, such as a blockage of the current travel lane by vehicles in an accident. In this case, the behavioral planning according to the disclosure could also plan to leave the lane and bypass the accident site on the lane for traffic in the opposite direction, along a corresponding target line proposed by the LLM with rule-based generated trajectories that slowly guide the vehicle around the accident site without risking a collision with the traffic traveling the opposite direction.

The rule-based planner prevents the planning of unsafe behavior, even if the LLM responds incorrectly. For example, if the LLM selects a lane that is blocked at the behavior level, then the planning by the rule-based planner provides for safe and comfortable behavior along that incorrectly selected lane, by stopping. Thus, the rule-based planner guarantees the safety of the behavioral planning according to the disclosure.

The behavioral planning concept according to the disclosure is also particularly suitable for behavioral planning in interactive scenarios, such as a lane change in dense traffic. The ego vehicle must thereby clarify its own intention to the traffic in the adjacent lane so that they can react, for example by braking to create a sufficient gap for changing lanes. Rule-based planners alone are only able to poorly represent this type of interaction. In principle, an LLM is able to understand such complex interactions. Consequently, in the proposed system, it could selectively choose a behavior that conveys this intention to the adjacent traffic, for example by deviating from its own lane without leaving it. The rule-based planner would comfortably and safely follow this behavior without “understanding” the interaction. Once the adjacent traffic creates a gap, the LLM would select a lane change as appropriate behavior, which the rule-based planner can then implement.

What is claimed is:

1. A computer-implemented method for planning a behavior of a vehicle in a traffic scene, the method comprising:
generating a scene representation of the traffic scene based on aggregated scene-specific information;
using a rule-based planner to perform behavioral planning based on the scene representation, the scene representation replicating at least one planning scenario from a planner-specific set of predefined planning scenarios;
selecting the at least one planning scenario using a text-based neural network;
generating, based on the scene representation, at least one text query describing the traffic scene for the text-based neural network, wherein the at least one text query requests a behavioral recommendation supported by the planner-specific set of predefined planning scenarios; and
assigning the text-based behavioral recommendation generated by the text-based neural network based on the at least one text query to at least one of the predefined planning scenarios in order to base the behavioral planning of the rule-based planner on the at least one planning scenario.

2. The computer-implemented method according to claim 1, wherein a large language model is used for the selection of the at least one planning scenario.

3. The computer-implemented method according to claim 1, wherein the set of predefined planning scenarios comprises at least one of (i) driving along a target line in a lane, (ii) adjusting to a predefined minimum distance from a vehicle ahead, (iii) adjusting to a target speed, (iv) changing lanes, and (v) avoiding an obstacle.

4. The computer-implemented method according to claim 1, further comprising:
generating the at least one text query for the text-based neural network in a rule-based manner,
wherein a uniform, fixed, and predefined structure with predefined semantic blocks in a specified format is used for the at least one text query.

5. The computer-implemented method according to claim 1, wherein the text-based behavioral recommendation of the neural network is analyzed in a rule-based manner and assigned to at least one of the predefined planning scenarios of the rule-based planner.

6. The computer-implemented method according to claim 1, further comprising:
based on the behavioral recommendation of the neural network, generating at least one target line for movement of the vehicle as input for the rule-based planner,
wherein the rule-based planner provides at least one behavioral planning provided as trajectory data describing a spatial and temporal movement of the vehicle along the at least one target line.

7. A computer-implemented system for behavioral planning of at least one vehicle in a traffic scene, the system comprising:
a perception layer configured to aggregate scene-specific information and to generate at least one scene representation of the traffic scene;
at least one rule-based planner configured to perform behavioral planning corresponding to at least one planning scenario from a planner-specific set of predefined planning scenarios based on the at least one scene representation generated by the perception layer;
a text-based neural network configured to select at least one of the predefined planning scenarios to use for the behavioral planning of the rule-based planner;
a prompt generator configured to generate text queries for the text-based neural network based on the at least one scene representation generated by the perception layer, wherein a behavioral recommendation is requested with each of the text queries from a scope of the planner-specific set of predefined planning scenarios; and
an evaluation module configured to assign the behavioral recommendations generated by the text-based neural network to at least one of the predefined planning scenarios.

8. The computer-implemented system according to claim 7, wherein the text-based neural network is implemented as a large language model.
